(19) United States
(12) Patent Application Publication
(10) Pub. No.: US 2009/0059267 A1
(43) Pub. Date: Mar. 5, 2009

(54) IMAGE FORMING SYSTEM, MANAGEMENT APPARATUS, AND CONTROL METHODS THEREOF

(75) Inventor: Masayuki Sato, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/197,491

(22) Filed: Aug. 25, 2008

(30) Foreign Application Priority Data
Aug. 29, 2007 (JP) 2007-223089

(51) Int. Cl. G06K 15/02

(52) U.S. Cl. 358/1.14

(57) ABSTRACT

An image forming system is provided which controls usage of a plurality of image forming apparatuses connected to a network for each user of the image forming system. Usage of the plurality of image forming apparatuses is permitted or prohibited based on information in a disable flag associated with each user.

### BACKGROUND OF THE INVENTION

1. Field of the Invention

The present invention relates to an image forming system to which a plurality of image forming apparatuses are connected, a management apparatus, and control methods thereof.

2. Description of the Related Art

In an image forming system to which a plurality of image forming apparatuses are connected, a management apparatus or system used to limit the number of sheets to be used in image formation for each operator is known. Japanese Patent Laid-Open No. 2006-209402 has proposed a management apparatus for an image forming apparatus, which manages the number of sheets used by an operator in real time even in a system to which a plurality of image forming apparatuses are connected. This management apparatus is implemented by storing an identification number, the number of actual sheets used, and a usage upper limit value of an operator in an IC card inserted in an image forming apparatus upon execution of image formation.

More specifically, the management apparatus for an image forming apparatus described in Japanese Patent Laid-Open No. 2006-209402 allows execution of image formation when the difference between the number of actual sheets used and the usage upper limit value acquired from the IC card is greater than or equal to the input number of sheets to be used in image formation upon execution of image formation. Upon completion of image formation, the management apparatus updates the number of actual sheets used held in the IC card.

While the related art can execute limitation management of the number of sheets to be used, it includes some limitations. For example, the related art cannot restrict illicit use in which a user executes image formation using the same identifier information as that stored in an IC card of the given user. Also, the related art cannot restrict illicit use in which a user executes image formation using an IC card and simultaneously executes image formation in another image forming apparatus using identifier information of that IC card. More specifically, a plurality of image formation processes using the same identifier information can be simultaneously executed in a plurality of image forming apparatus. If such image formation processes are executed, the number of result sheets managed for each item of identifier information cannot be appropriately updated, and it is possible to perform image formation in excess of the limit on the number of sheets to be used.

In order to avoid such illicit use, a system which can disable usage of a plurality of image forming apparatuses connected to a network by a user's request is effective. For example, when a user does not use a plurality of image forming apparatuses connected to the network for a long time, it is desirable to disable usage of image forming apparatuses using the identifier information of that user. While the user is using one image forming apparatus, it is desirable to disable usage of other image forming apparatuses connected to the network.

### SUMMARY OF THE INVENTION

The present invention enables realization of an image forming system which disables usage of a plurality of image forming apparatuses connected to a network for each item of identifier information.

According to one aspect of the present invention, a management apparatus in an image forming system, the image forming system including a plurality of image forming apparatuses, the management apparatus, which manages whether to use one of the plurality of image forming apparatuses, and a management server that manages usage of the plurality of image forming apparatuses for each user of the image forming system, the management apparatus including a read-out unit configured to read out user identifier information stored in a recording medium connectable to the management apparatus, an acquisition unit configured to acquire, from the management server, disabling information corresponding to the read out user identifier information and indicating whether to disable usage of the plurality of image forming apparatuses, an update unit configured to update the disabling information in the management server, when disabling usage of the plurality of image forming apparatuses is selected or when resumption of usage of the plurality of image forming apparatuses is selected, after the acquisition unit acquires the disabling information corresponding to the user identifier information, and a usage limitation unit configured to prohibit a user corresponding to the user identifier information from executing image formation when the disabling information indicates disabling of usage and to permit the user corresponding to the user identifier information to execute image formation when the disabling information does not indicate disabling of usage.

Further features of the present invention will become apparent from the following description of exemplary embodiments with reference to the attached drawings.

### BRIEF DESCRIPTION OF THE DRAWINGS

FIG. 1A is a diagram showing an example of an image forming system 100 according to the first embodiment;

FIG. 1B is a block diagram showing an example of control functions of respective apparatuses connected to the image forming system 100 according to the first embodiment;

FIG. 2 is a view showing information stored in storage units of respective apparatuses according to the first embodiment;

FIG. 3 is a flowchart showing the sequence of usage disabling processing according to the first embodiment;

FIG. 4 is a flowchart showing the sequence of usage resumption processing according to the first embodiment;

FIG. 5 is a view showing a setting screen 500 displayed on a display unit 133 of a management apparatus 104 according to the first embodiment;

FIG. 6A is a view showing an example of a selection screen 610 according to the first embodiment;

FIG. 6B is a view showing an example of a selection screen 620 according to the first embodiment;

FIG. 7 is a flowchart showing the processing sequence upon image formation according to the first embodiment; and

FIG. 8 is a flowchart showing the processing sequence upon image formation according to the second embodiment.

### DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Arrangement of System

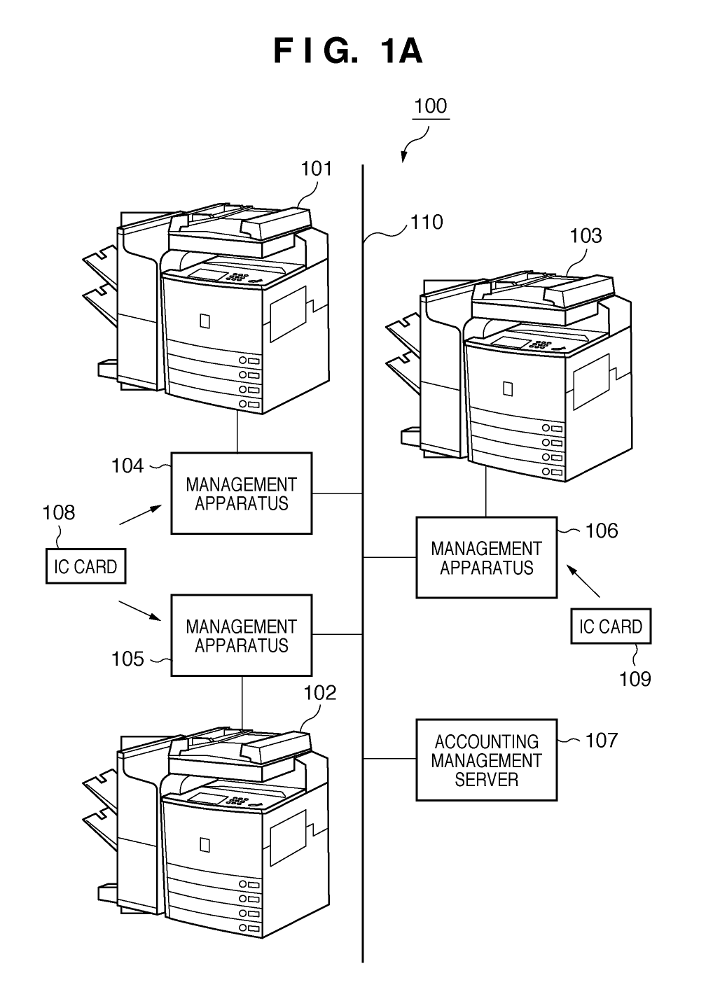

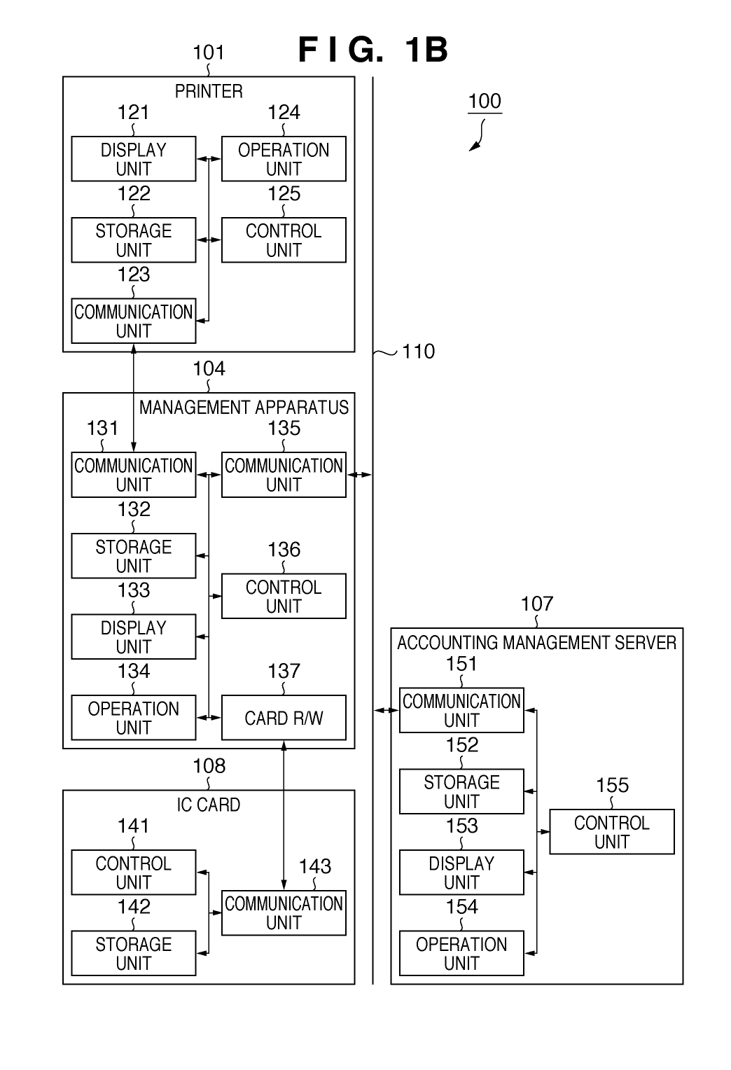

The first embodiment will be described with reference to FIGS. 1A to 7. FIG. 1A shows an example of an image forming system 100 according to the first embodiment.

As shown in FIG. 1A, the image forming system 100 includes a plurality of printers 101, 102, and 103, a plurality of management apparatuses 104, 105, and 106 to which the printers 101 to 103 are respectively connected, and an accounting management server 107. These apparatuses are connected via a network 1101, which may be a wired network, a wireless network, or a combination of the two. While three printers are described in the present embodiment, the number of printers that can be included in the image forming system 100 is not limited to three.

The printers 101 to 103 may be multi-function peripherals (MFPs) which include not only a print function but also copy and facsimile functions. For example, when operation modes such as a monochrome or full-color mode, a single- or double-sided mode, an enlargement or reduction mode, paper size, or the number of output sheets are set, each of the printers 101 to 103 executes a print operation based on the settings, and outputs images on a predetermined sheets.

In the following description of the present embodiment, for explanation purposes only, the monochrome or full-color mode is adopted as the operation mode. However, the present invention is not limited to such a specific operation mode, and can adopt a plurality of other operation modes set in the printer 101. The printers 101 to 103 are respectively connected to the management apparatuses 104 to 106, and can exchange commands and data bi-directionally. In the present embodiment, the printers and management apparatuses are independently arranged, but in another embodiment, they may be integrated with each other.

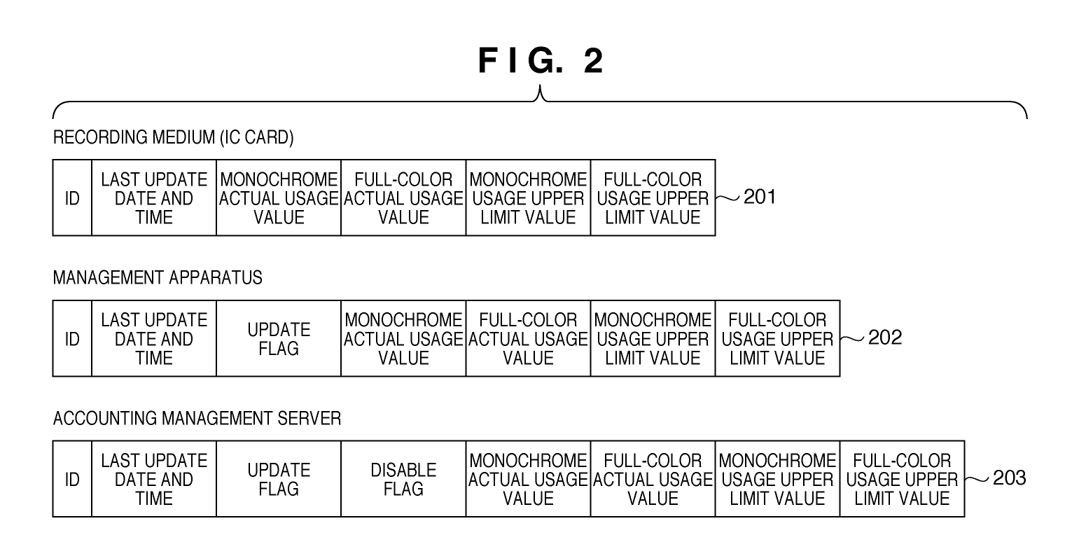

The management apparatuses 104 to 106 manage the limited numbers of sheets to be used for respective users, and limit usage of the connected printers. The management apparatuses 104 to 106 can receive IC cards 108 and 109, and identify the users based on identifier information (ID) stored in the IC cards. Furthermore, the management apparatuses 104 to 106 read out information stored in the IC cards to limit the print operations of the users. An IC card is distributed to each user or group, and has unique ID and usage limitation information. The usage limitation information is described below with reference to FIG. 2. In the following description of the present embodiment, the IC cards are recording media, but other media, such as magnetic cards may be used as long as they can allow data read and write accesses.

The accounting management server 107 stores usage limitation information, update information, disabling information, etc. for each ID. Note that the disabling information is information indicating usage permitted states of the printers included in the image forming system 100 for each ID. Details of these items of information are described below with reference to FIG. 2. The accounting management server 107 and the management apparatuses 104, 105, and 106 can exchange commands and data bi-directionally via the network 110.

The control functions of the respective apparatuses connected to the image forming system 100 will are described with reference to FIG. 1B. FIG. 1B shows an example of the control functions of the respective apparatuses connected to the image forming system 100 according to the first embodiment. For discussion purposes, printer 101 and management apparatus 104 will be described with respect to FIG. 1B.

The printer 101 includes a display unit 121, storage unit 122, communication unit 123, operation unit 124, and control unit 125. The display unit 121 displays various types of information to the user. The storage unit 122 includes, for example, a ROM and RAM, and the control unit 125 reads out the stored contents and writes information to and from the storage unit 122. A communication unit 131 controls exchange of data and commands with the management apparatus 104. The operation unit 124 is operated by the user, and is used to designate, for example, print conditions in the printer 101. The display unit 121 and operation unit 124 may be integrated together, such as a touch panel. The control unit 125 controls the printer 101 and executes the functions of the printer 101.

The management apparatus 104 includes the communication unit 131, a communication unit 135, storage unit 132, display unit 133, operation unit 134, control unit 136, and card R/W 137. The control unit 136 controls the communication units 131 and 135, storage unit 132, display unit 133, operation unit 134, and card R/W 137, and can exchange data and commands with these units. According to the present embodiment, the control unit 136 serves as acquisition means, display control means, update means, and usage limitation means.

The communication unit 131 exchanges data with the printer 101. The communication unit 135 exchanges data with the accounting management server 107. The storage unit 132 comprises a ROM and RAM used by the control unit 136. The storage unit 132 stores, for example, ID information and usage limitation information corresponding to each ID. The display unit 133 displays various kinds of information to the user. The operation unit 134 is operated by the user, and allows the user to input, for example, the number of sheets to be used for each operation mode. The display unit 133 and operation unit 134 may be integrated together, such as a touch panel. The card R/W 137 reads out, from the IC card 108, identifier information required to identify a user who uses the printer 101, and usage limitation information required to limit usage of the printer by that user. The card R/W 137 writes usage limitation information in the IC card 108.

The IC card 108 includes a control unit 141, storage unit 142, and communication unit 143. The control unit 141 controls the storage unit 142 and communication unit 143. The storage unit 142 includes a ROM and RAM. For example, the ROM stores ID information to prohibit that information from being rewritten, while the RAM stores usage limitation information which is rewritten. The communication unit 143 exchanges data and commands with the card R/W 137 when the IC card 108 is connected to the management apparatus 104.

The accounting management server 107 includes a control unit 155, communication unit 151, storage unit 152, display unit 153, and operation unit 154. The control unit 155 controls the communication unit 151, storage unit 152, display unit 153, and operation unit 154, and can exchange data and commands with these units. The communication unit 151 exchanges various data with the management apparatus 104. The storage unit 152 stores items of ID information received from the management apparatus 104, and items of usage limitation information corresponding to the respective items of ID information. The display unit 153 displays various kinds of information. The operation unit 154 is operated by a user, and is used to change the usage limitation information of each user. The display unit 153 and operation unit 154 may be integrated together, such as a touch panel.

Among the information stored in the storage units of the above-described apparatuses, information mainly required to implement the present invention will be described with reference to FIG. 2. Each storage unit may include other kinds of information.

FIG. 2 shows information stored in the storage units of the respective apparatuses according to the first embodiment. The storage unit 142 of the IC card 108 stores an ID and usage limitation information corresponding to that ID, as denoted by reference numeral 201. More specifically, the usage limitation information includes a last update date and time, actual usage values for respective operation modes (monochrome actual usage value and full-color actual usage value), and usage upper limit values for respective operation modes (monochrome usage upper limit value and full-color usage upper limit value). Note that the last update date and time indicates the date and time when the IC card 108 was used last. The actual usage values indicate the accumulated numbers of printed sheets on, for example, a monthly basis, and are updated every time a print operation is executed. The usage upper limit values indicate the numbers of usable sheets on, for example, a monthly basis.

The storage unit 132 of the management apparatus 104 includes update flag information in addition to the items of information denoted by reference numeral 201, as denoted by reference numeral 202. This update flag indicates whether to update information of a new actual usage value or usage upper limit value in the IC card 108 that stores this ID information. Note that the storage unit 132 stores the ID information, last update date and time, actual usage values, and upper limited values read from the IC card 108 on, for example, a monthly basis. The storage unit 132 stores usage limitation information and an update flag in correspondence with an ID assigned to each user.

The storage unit 152 of the accounting management server 107 includes disable flag information in addition to the items of information denoted by reference numeral 202, as denoted by reference numeral 203. The disable flag information indicates whether to disable use of the printers included in the image forming system 100. For example, if the disable flag is “0”, it indicates a usage permitted state of the printers. If the disable flag is “1”, it indicates a usage disable state of the printers. Note that the storage unit 152 stores items of information on, for example, a monthly basis as in the storage unit 132. The storage unit 152 stores usage limitation information, an update flag, and disable flag in correspondence with an ID assigned to each user. Furthermore, on the storage unit 152, total areas used to calculate totals of items of information received from the management apparatus 104 are assured.

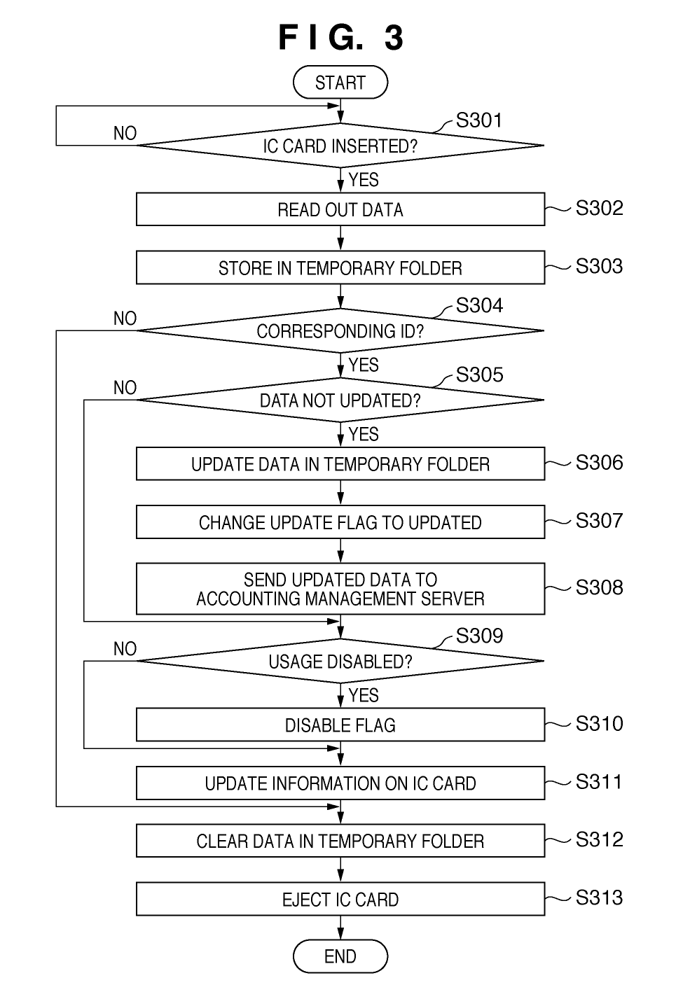

The usage disabling processing and usage resumption processing of the printers included in the image forming system 100 of the present embodiment is described. The present embodiment presumes that the processing for stopping use of the printers by a user corresponding to a specific ID and the processing for resuming use of the printers are executed in independent sequences. For example, a case will be assumed wherein when a user does not use the printers for a long time, usage of the image forming system 100 is disabled, and is resumed later. Therefore, the usage disabling processing and usage resumption processing are not executed in a series of sequences. Furthermore, in the present embodiment, it is assumed that usage of all the printers included in the image forming system 100 is disabled or resumed. FIG. 3 is a flowchart showing the sequence of the usage disabling processing according to the first embodiment. The following processing is controlled by the control unit 136 of the management apparatus 104.

The usage disabling processing will be described first. The control unit 136 determines in step S301 if the IC card 108 is inserted into the card R/W 137. If no IC card 108 is inserted, the control unit 136 periodically repeats this determination step. If the IC card 108 is inserted, the process advances to step S302.

In step S302, the control unit 136 reads out data (the ID, last update date and time, actual usage values, and usage upper limit values denoted by reference numeral 201) of the IC card 108. In step S303, the control unit 136 stores the read out data in a temporary memory folder. This processing is required to temporarily move away the read out data.

Subsequently, the control unit 136 authenticates the read out ID. There are two authentication methods: authentication using ID information stored in the storage unit 132 in the management apparatus 104, and that using ID information stored in the storage unit 152 in the accounting management server 107. More specifically, the authentication is to determine whether the read out ID is stored in the storage unit 132 or 152. In the present embodiment, both authentication methods can be used. However, since usage of all printers included in the image forming system 100 is to be disabled, the following description will be given using the method of performing authentication in the accounting management server 107. Therefore, in step S304 the control unit 136 notifies the accounting management server 107 of the read out ID, and inquires whether that ID is an ID managed by the accounting management server 107. In this case, in the accounting management server 107, the control unit 155 determines using the notified ID as a search keyword if the storage unit 152 stores the corresponding ID, and returns a response indicating the determination result to the management apparatus 104.

Upon reception of the response indicating that the ID is not managed from the accounting management server 107, the control unit 136 displays error information indicating that usage of the printer is not permitted on the display unit 133 of the management apparatus 104. After that, the control unit 136 clears the data stored in the temporary memory folder, thus ending the processing.

On the other hand, upon reception of the response indicating that the ID is managed from the accounting management server 107, the process advances to step S305. Note that data corresponding to that ID are sent together with the response from the accounting management server 107. The control unit 136 serves as acquisition means, and stores these data in a temporary area of the storage unit 132. The control unit 136 determines in step S305 using the data received from the accounting management server 107 if the update flag is information indicating that data has not yet been updated. For example, if the update flag is “0”, this indicates that data has not yet been updated. If the flag is “1”, this indicates that data has already been updated. If the update flag indicates that data has not yet been updated, the process proceeds to step S306, otherwise, the process proceeds to step S309.

In step S306, the control unit 136 updates the data in the temporary memory folder, which is read out from the IC card 108, by the data in the temporary area, which is received from the accounting management server 107. Next, in step S307 the control unit 136 changes the update flag of the data in the temporary area to a value indicating that data has been updated (“1” in this case). Then, in step S308, the control unit 136 sends the ID information of the updated card to the accounting management server 107, thus requesting the server 107 to update the data in the storage unit 152.

The control unit 136 determines in step S309 whether to disable usage of all the printers included in the image forming system 100 by the user of the corresponding ID. More specifically, the control unit 136 serves as display control means, and controls the display unit (display device) 133 to display a first selection screen that prompts the user to select whether to disable usage of a plurality of printers. Note that this step presumes that the disable flag of the ID information acquired from the accounting management server 107 is “0”, that is, that usage of the printers is permitted. The user inputs a choice as whether to disable usage of the printers to the operation unit (input device) 134 of the management apparatus 104 via the first selection screen. That is, in the process in step S309, the control unit 136 determines, based on a signal from the operation unit 134 as a user's input, whether to disable usage of the printers.

If usage of the printers is not disabled, the process proceeds to step S311, otherwise, the process advances to step S310. In step S310, the control unit 136 serves as update means, and requests the accounting management server 107 to change the disable flag corresponding to the ID managed in the storage unit 152 in the server 107 to a disable state (usage prohibition state). After that, in step S311 the control unit 136 updates the data of the IC card 108 by the data managed in the storage unit 152 in the accounting management server 107 and correspond to the ID of the IC card 108. In this case, the control unit 136 updates the data of the IC card 108 using the data in the temporary area.

After the IC card 108 is updated, the control unit 136 clears the data in the temporary memory folder in step S312. In step S313, the control unit 136 controls the card R/W 137 to eject the IC card 108, thus ending the processing.

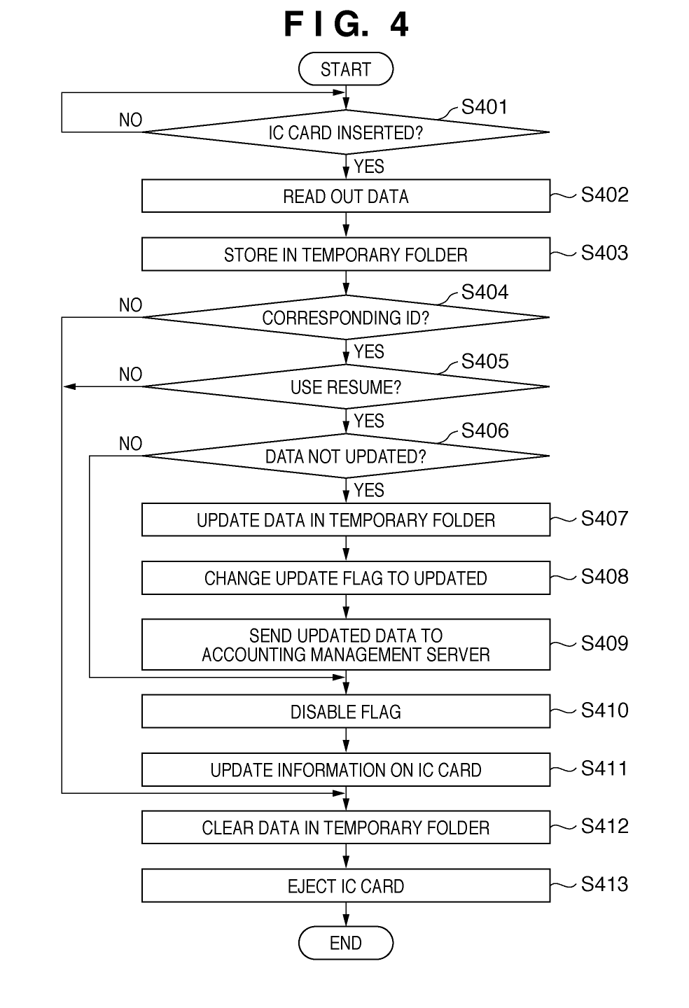

The usage resumption processing is described with respect to FIG. 4. FIG. 4 is a flowchart showing the sequence of the usage resumption processing according to the first embodiment. The following processing is controlled by the control unit 136 of the management apparatus 104. Note that since the processes in steps S401-S404 are the same as those in steps S301-S304, a description of steps S401-S404 will not be provided herein.

The control unit 136 determines in step S405 whether to resume usage of all the printers included in the image forming system 100 by the user of the corresponding ID. More specifically, the control unit 136 serves as display control means, and controls the display unit 133 to display a second selection screen that prompts the user to select whether to resume usage of a plurality of printers. Note that this process presumes that the disable flag of the ID information acquired from the accounting management server 107 is “1”, that is, that usage of the printers is disabled (prohibited). The user inputs a choice whether to resume usage of the printers to the operation unit 134 of the management apparatus 104 via the second selection screen. More specifically, in the process of step S405, the control unit 136 determines, based on a signal from the operation unit 134 as a user's input, whether to resume usage of the printers.

If usage of the printers is not resumed, the process proceeds to step S412, otherwise, the process advances to step S406. The control unit 136 determines in step S406, using the data received from the accounting management server 107, if the update flag is information indicating that data has not yet been updated. For example, if the update flag is “0”, it indicates that data has not yet been updated. If the flag is “1”, it indicates that data has already been updated. If the update flag indicates that data has not yet been updated, the process advances to step S407, otherwise, the process proceeds to step S410.

In step S407, the control unit 136 updates the data in the temporary memory folder, which is read out from the IC card 108, by the data in the temporary area, which is received from the accounting management server 107. In step S408, the control unit 136 changes the update flag of the data in the temporary area to a value indicating that data has been updated (“1” in this case). Next, in step S409, the control unit 136 sends the ID information of the updated card to the accounting management server 107, thus requesting the server 107 to update the data in the storage unit 152.

In step S410, the control unit 136 serves as update means, and requests the accounting management server 107 to change the disable flag corresponding to the ID managed in the storage unit 152 in the server 107 to the resume state (usage permitted state). After that, in step S411 the control unit 136 updates the data of the IC card 108 by data managed in the storage unit 152 in the accounting management server 107 and correspond to the ID of the IC card 108. In this case, the control unit 136 updates the data of the IC card 108 using the data in the temporary area.

After the IC card 108 is updated, the control unit 136 clears the data in the temporary memory folder in step S412. In step S413, the control unit 136 controls the card R/W 137 to eject the IC card 108, thus ending the processing.

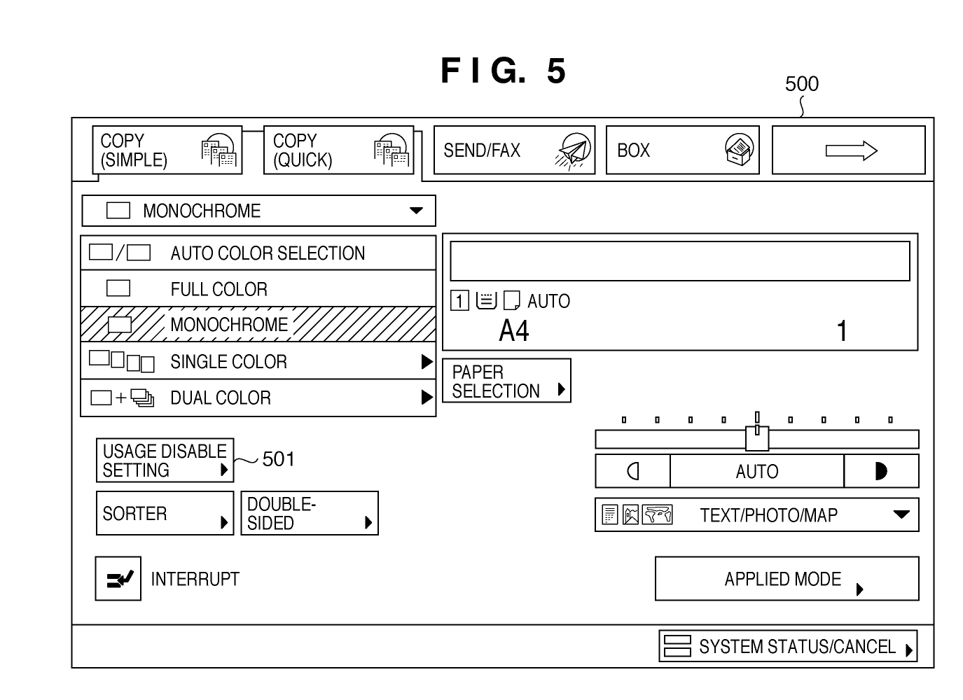

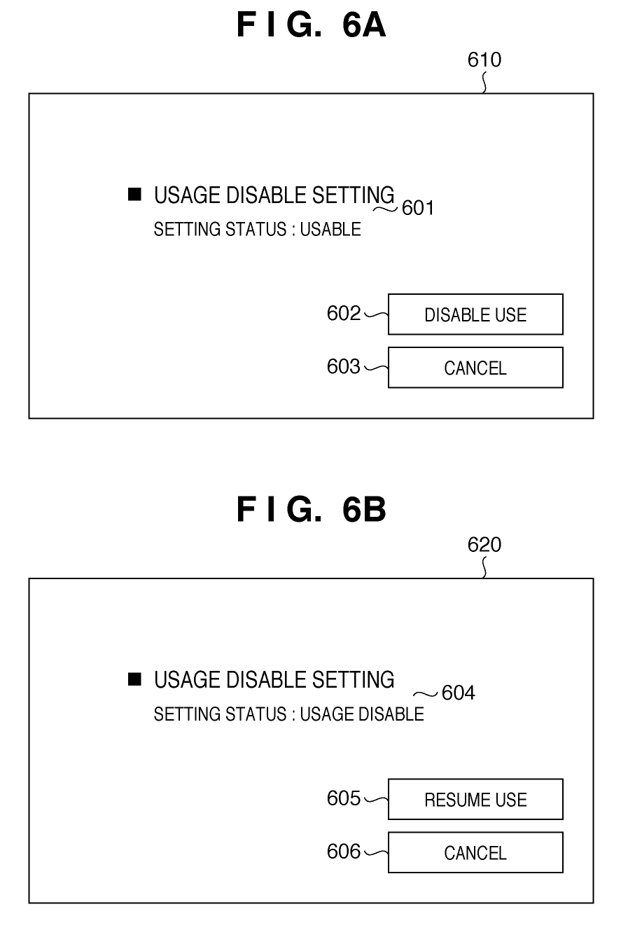

The first selection screen or second selection screen displayed in step S309 or S405 will be described with reference to FIGS. 5 to 6B. Each screen is one application example, and the screen configuration is not limited. FIG. 5 shows a setting screen 500 displayed on the display unit 133 of the management apparatus 104 according to the first embodiment. When the user inserts the IC card 108 into the management apparatus 104 and authentication has succeeded, the setting screen 500 is displayed on the display unit 133. The setting screen 500 includes various soft keys (implemented by a touch panel in this embodiment) used to designate print conditions. Referring to FIG. 5, reference numeral 501 denotes a soft key used to select a setting to disable or resume usage of the printers included in the image forming system 100. The user selects the soft key 501 when the user wants to set to disable or resume usage of the printers.

FIG. 6A shows an example of a selection screen 610 according to the first embodiment. FIG. 6B shows an example of a selection screen 620 according to the first embodiment. The selection screen (first selection screen) 610 and selection screen (second selection screen) 620 are displayed according to the current setting status when the user selects the soft key 501 on the setting screen 500. The selection screen 610 is displayed when the current setting status is a usage permitted state, that is, when the disable flag is “0”. On the other hand, the selection screen 620 is displayed when the current setting status is a disable state, that is, when the disable flag is “1”.

As shown in FIG. 6A, the selection screen 610 is includes a current setting status 601, and soft keys 602 and 603. Upon selection of the soft key 602, the control unit 136 determines in the aforementioned process of step S309 that the user selects disabling of usage. On the other hand, upon selection of the soft key 603, the control unit 136 determines that the user cancels disabling of usage.

As shown in FIG. 6B, the selection screen 620 is displayed to include a current setting status 604, and soft keys 605 and 606. Upon selection of the soft key 605, the control unit 136 determines in the aforementioned process of step S405 that the user selects resumption of usage. On the other hand, upon selection of the soft key 606, the control unit 136 determines in the aforementioned process of step S405 that the user cancels resumption of usage.

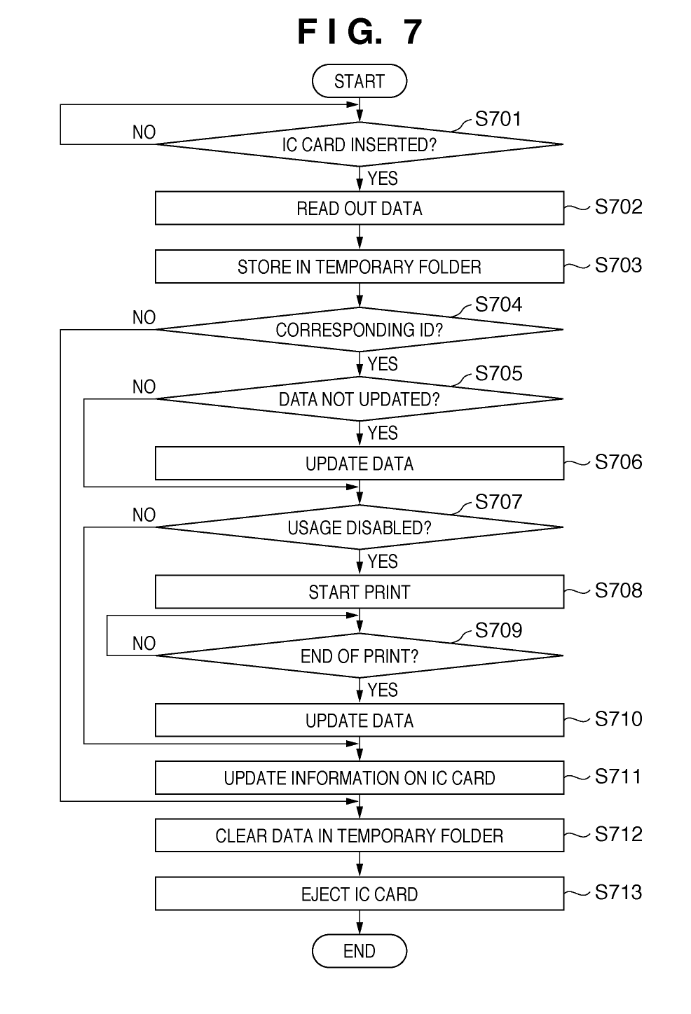

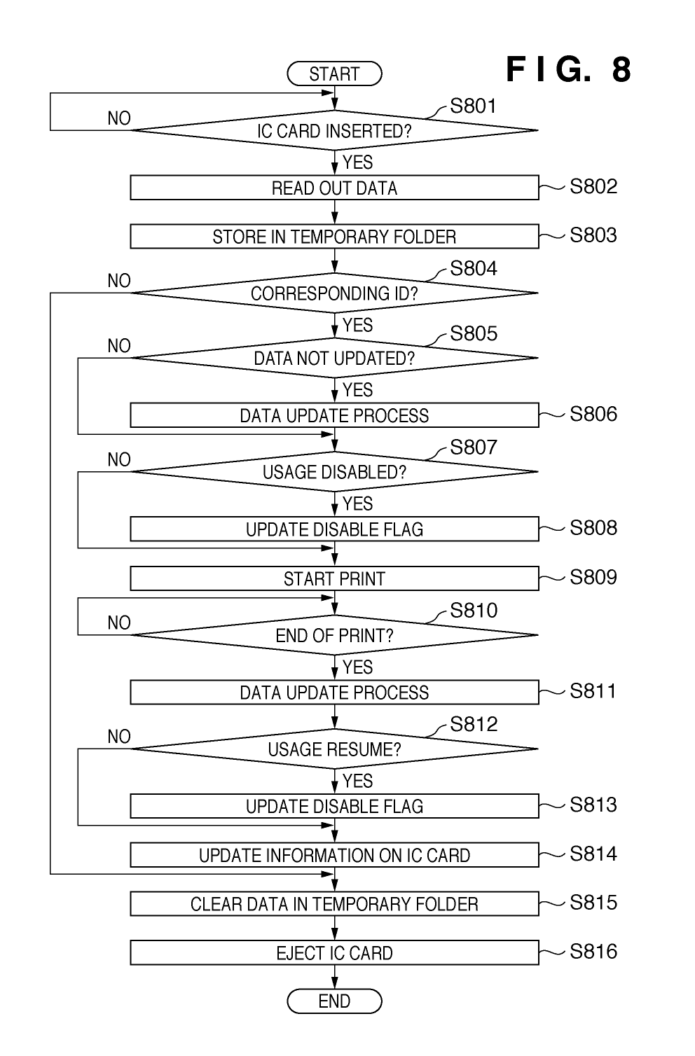

The sequence for controlling a usage limitation upon image formation will be described with reference to FIG. 7. FIG. 7 is a flowchart showing the processing sequence upon image formation according to the first embodiment. The following processing is controlled by the control unit 136 of the management apparatus 104. Since the processes in steps S701-S705 are the same as those in steps S301-S305, a description of these steps is omitted herein. Also, since step S706 describes the processes described above in steps S306-S308 collectively, a description of this step is omitted herein.

The control unit 136 determines in step S707 if the disable flag acquired from the accounting management server 107 is information indicating disabling of usage of the printers. That is, the control unit 136 determines if the flag is “1”. In case of a usage disable state, the process proceeds to step S710. On the other hand, if usage is permitted, the process advances to step S706. In this case, the control unit 136 serves as usage limitation means.

In step S708, the printer 101 starts a print operation. The control unit 136 is notified of the print condition set by the user in the printer 101 via the communication units 123 and 131. The control unit 136 determines if the notified print condition falls within an allowable range of the usage limitation information, and notifies the printer 101 of the determination result. If the print condition falls outside the allowable range, the control unit 136 controls the printer 101 to abort the print operation; otherwise, it controls the printer 101 to start the print operation. More specifically, when a monochrome print operation of 20 sheets is set as the print condition, the control unit 136 determines, based on the monochrome actual usage value and monochrome use usage upper limit value of the usage limitation information stored in the temporary folder, if the print condition falls within the allowable range. If the print condition falls within the allowable range, the print operation is allowed. For example, if a value obtained by subtracting the monochrome actual usage value from the monochrome upper usage limit value is greater than or equal to 20, the control unit 136 permits the print operation. If it is smaller than 20, the control unit 136 aborts the print operation.

The control unit 136 determines in step S709 if the print operation is complete. If the print operation is not complete yet, the control unit 136 periodically repeats this determination process. If the print operation is complete, the control unit 136 updates the data in the temporary folder and those stored in the storage unit 107 in the accounting management server 107 by data after the print operation in step S710.

After that, in step S711 the control unit 136 updates the data of the IC card 108 by data managed in the storage unit 152 in the accounting management server 107 and correspond to the ID of the IC card 108. In this case, the control unit 136 updates the data of the IC card 108 using the data in the temporary area.

After the IC card 108 is updated, the control unit 136 clears the data in the temporary memory folder in step S712. In step S713, the control unit 136 controls the card R/W 137 to eject the IC card 108, thus ending the processing.

As described above, the image forming system 100 according to the present embodiment can be implemented as an image forming system which includes a plurality of image forming apparatuses, a plurality of management apparatuses, and a accounting management server, and is configured by connecting the respective apparatuses via a network. The accounting management server stores disabling information indicating whether to disable usage of the plurality of image forming apparatuses in correspondence with unique identifier information assigned to each user. Each management apparatus reads out identifier information, which is stored in a recording medium that can be connected to the management apparatus and is used to identify the user, and acquires disabling information corresponding to the read out identifier information from the accounting management server. Furthermore, the management apparatus updates a disable flag according to a user's request. At the time of image formation, the management apparatus limits usage of the image forming apparatuses based on information of the disable flag. In this way, this image forming system can disable or resume usage of the image forming apparatuses included in the system for each unique identifier information assigned to that user in accordance with the user's request.

Note that the present invention is not limited to the aforementioned embodiment, and various modifications can be made. For example, the management apparatus may prohibit usage of all the image forming apparatuses included in the system when the disabling information stored in the accounting management server indicates disabling of usage. In this way, when the user does not use the image forming system for a long time, security can be assured by temporarily disabling usage of the image forming apparatuses using the identifier information.

### Second Embodiment

A second embodiment will be described with reference to FIG. 8. The present embodiment prohibits print operations using identifier information of a given user in all other printers except for a printer which is currently used to execute a print operation. In the first embodiment, when the disable flag indicates disabling of usage, usage of all the printers in the image forming system 100 is prohibited. In the present embodiment, usage of all printers except for the printer to which the management apparatus inserted with the IC card is connected is disabled. In this way, illicit use using the same identifier information to perform a print operation while the user performs a print operation using that identifier information can be suppressed. If such print operation is permitted, the consistency of the usage limitation information and, especially, the actual usage values, may be impaired, and print operations beyond the usage upper limit values may be allowed, thus posing a problem.

FIG. 8 is a flowchart showing the processing sequence upon image formation according to the second embodiment. The following processing is controlled by the control unit 136 of the management apparatus 104. Since the processes in steps S801-S806 are the same as those in steps S301-S308, a description of these steps will be omitted herein.

The control unit 136 determines in step S807 whether to disable usage of the printers included in the image forming system 100 except for the printer 101 which is used by the user of the corresponding ID. More specifically, the control unit 136 serves as display control means, and controls the display unit (display device) 133 to display the first selection screen that prompts the user to select whether to disable usage of a plurality of printers. Note that this step presumes that the disable flag of the ID information acquired from the accounting management server 107 is “0”, that is, that usage of the printers is permitted. The user inputs a choice whether to disable usage of the printers to the operation unit (input device) 134 of the management apparatus 104 via the first selection screen. That is, in the process in step S807, the control unit 136 determines based on a signal from the operation unit 134 as a user's input whether to disable usage of the printers.

To disable usage of the printers, the process advances to step S808, otherwise, the process proceeds to step S809. In step S808, the control unit 136 updates the disable flag in the storage unit 152 corresponding to the identification of the user to information indicating disabling of usage via the network 110.

In step S809, the printer 101 starts a print operation. The control unit 136 is notified of the print condition set by the user in the printer 101 via the communication units 123 and 131. The control unit 136 determines if the notified print condition falls within an allowable range of the usage limitation information, and notifies the printer 101 of the determination result. If the print condition falls outside the allowable range, the control unit 136 controls the printer 101 to abort the print operation; otherwise, it controls the printer 101 to start the print operation.

The control unit 136 determines in step S810 if the print operation is complete. If the print operation is not complete yet, the control unit 136 periodically repeats this determination process. If the print operation is complete, the control unit 136 updates the data in the temporary folder and those stored in the storage unit 152 in the accounting management server 107 by data after the print operation in step S811.

The control unit 136 then determines in step S812 whether to resume usage of all the printers included in the image forming system 100 except for the printer 101 used by the user of the corresponding ID. More specifically, the control unit 136 serves as display control means, and controls the display unit 133 to display the second selection screen that prompts the user to select whether to resume usage of a plurality of printers. The user inputs a choice whether to resume usage of the printers to the operation unit 134 of the management apparatus 104 via the second selection screen. More specifically, in the process of step S812, the control unit 136 determines, based on a signal from the operation unit 134 as a user's input, whether to resume usage of the printers.

To resume usage of the printers, the process advances to step S813, otherwise, the process proceeds to step S814. In step S813, the control unit 136 updates the disable flag in the storage unit 152 corresponding to the identification of the user to information indicating resumption of usage via the network 110.

After that, in step 814 the control unit 136 updates the data of the IC card 108 by data managed in the storage unit 152 in the accounting management server 107 and correspond to the ID of the IC card 108. In this case, the control unit 136 updates the data of the IC card 108 using the data in the temporary area.

After the IC card 108 is updated, the control unit 136 clears the data in the temporary memory folder in step S815. In step S816, the control unit 136 controls the card R/W 137 to eject the IC card 108, thus ending the processing.

As described above, in the present embodiment, the disable flag indicates whether to disable usage of all printers except for the printer which is currently used by the user. The present embodiment may be used in combination with the first embodiment. In this case, such combined embodiment may be implemented using two different types of disable flags, or by increasing the amount of information contained in the disable flag (e.g., having the disable flag information expressed by one of “0”, “1”, and “2”).

As described above, the management apparatus according to the present embodiment may prohibit usage of all printers except for the printer used when the disabling information stored in the storage unit 152 indicates disabling of usage. Hence, this image forming system 100 can suppress illicit use using the same identifier information when the user uses the printer.

### Other Embodiments

In the first and second embodiments, disabling of usage of all printers included in the image forming system 100 or all printers except for the printer in use is controlled in accordance with the disable flag. However, the present invention is not limited to these control methods. For example, the present invention may control disabling or resuming usage of each individual printer. In this case, the disable flag in the usage limitation information denoted by reference numeral 203 in FIG. 2 needs to have independent fields for respective printers. More specifically, a method in which, for example, when the image forming system 100 includes four printers, the disable flag has a 4-bit field is available. By increasing the number of bits of the disable flag field in correspondence with the number of printers, disabling information corresponding to respective printers for respective bits can be set. For example, when usage of all printers is permitted, bits “0000” are set. When usage of two specific printers is disabled, bits “0101”, “0011”, etc., are set. Furthermore, in order to inquire of the user whether to disable the usage of the printers, the control unit 136 displays a selection screen (third selection screen) that allows the user to select printers to be disabled.

Various embodiments have been explained, and the present invention may be applied to either a system including a plurality of devices, or an apparatus consisting of a single device. For example, the present invention may be applied to a printer, a facsimile apparatus, a PC, a computer system including a server and client, etc.

The present invention can also be achieved when a software program that implements the functions of the aforementioned embodiments is directly or remotely supplied to a system or apparatus, and a computer included in the system or the like reads out and executes the supplied program code.

Therefore, the program code itself to be installed in the computer so as to make the computer implement the functions and processes of the present invention also implements the present invention. That is, the computer program itself for implementing the functions and processes is one form of the present invention.

In this case, the form of program is not particularly limited, and an object code, a program to be executed by an interpreter, script data to be supplied to an OS, and the like may be used as long as they have the program function.

As a recording medium used to supply the program, for example, a floppy disk, hard disk, optical disk, magneto-optical disk, MO, CD-ROM, CD-R, CD-RW, and the like may be used. Also, as the recording medium, a magnetic tape, nonvolatile memory card, ROM, DVD (DVD-ROM, DVD-R), and the like may be used.

The program may be downloaded from a web page on the Internet using a browser of a client computer. That is, the computer program itself of the present invention or a compressed file including an automatic installation function may be downloaded from the web page to a recording medium such as a hard disk or the like. Also, the program codes that form the program of the present invention may be segmented into a plurality of files, which may be downloaded from different web pages. That is, a WWW server that allows a plurality of computer users to download program files required to implement the functions and processes of the present invention may often be a requisite of the present invention.

Furthermore, a storage medium, such as a CD-ROM, which stores the encrypted program of the present invention, may be delivered to the users. In this case, only users who have cleared a predetermined condition may be allowed to download key information that decrypts the encrypted program from a homepage via the Internet, and may decrypt the encrypted program using that key information to install the program on their computers.

The functions of the aforementioned embodiments can be implemented when the computer executes the read out program. Note that an OS, which runs on the computer, may execute some or all of actual processes based on an instruction of the program. Of course, in this case as well, the functions of the aforementioned embodiments can be implemented.

Moreover, the program read out from the recording medium may be written in a memory of a function expansion board or function expansion unit, which is inserted in or connected to the computer. A CPU or the like equipped on that function expansion board or unit may execute some or all of actual processes based on an instruction of that program. The functions of the aforementioned embodiments may also be implemented in this way.

The present invention can provide, for example, an image forming system which can disable usage of a plurality of image forming apparatuses connected to a network for each item of identifier information, a management apparatus, control methods thereof, and a computer program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Laid-Open No. 2007-223089 filed on Aug. 29, 2007, which is hereby incorporated by reference herein in its entirety.

What is claimed:

1. A management apparatus in an image forming system, the image forming system including a plurality of image forming apparatuses, the management apparatus, which manages whether to use one of the plurality of image forming apparatuses, and a management server that manages usage of the plurality of image forming apparatuses for each user of the image forming system, the management apparatus comprising:
a read-out unit configured to read out user identifier information stored on a recording medium connectable to the management apparatus;
an acquisition unit configured to acquire, from the management server, disabling information corresponding to the read out identifier information and indicating whether to disable usage of the plurality of image forming apparatuses;
an update unit configured to update the disabling information stored in the management server when disabling usage of the plurality of image forming apparatuses is selected or when resumption of usage of the plurality of image forming apparatuses is selected; and
a usage limitation unit configured to prohibit a user corresponding to the user identifier information from executing image formation when the disabling information indicates disabling of usage and to permit the user corresponding to the user identifier information to execute image formation when the disabling information does not indicate disabling of usage.

2. The apparatus according to claim 1, wherein the usage limitation unit prohibits usage of all the plurality of image forming apparatuses when the disabling information indicates disabling of usage.

3. The apparatus according to claim 1, wherein the usage limitation unit prohibits usage of image forming apparatuses except for an image forming apparatus used by the user when the disabling information indicates disabling of usage.

4. The apparatus according to claim 1, wherein the usage limitation unit prohibits usage of an image forming apparatus according to disabling information for each image forming apparatus.

5. The apparatus according to claim 1, wherein the usage limitation information used to limit usage of the image forming apparatus is stored on the recording medium, and
the update unit updates the disabling information and the usage limitation information stored on the recording medium.

6. A method for processing data in an image forming system, which includes a plurality of image forming apparatuses, a management apparatus that manages whether to use one of the plurality of image forming apparatuses, and a management server that manages usage of the plurality of image forming apparatuses for each user of the image forming system, the method comprising:
reading out user identifier information stored in a recording medium connectable to the management apparatus;
acquiring, from the management server, disabling information corresponding to the read out user identifier information and indicating whether to disable usage of the plurality of image forming apparatuses;
updating the disabling information stored on the management server when disabling usage of the plurality of image forming apparatuses is selected or when resumption of usage of the plurality of image forming apparatuses is selected; and
prohibiting a user corresponding to the user identifier information from executing image formation when the disabling information indicates disabling of usage and permitting the user corresponding to the user identifier information to execute image formation when the disabling information does not indicate disabling of usage.

7. A computer-readable storage medium storing a computer program for making a computer execute the method of claim 6.
